(19) United States
(12) Patent Application Publication
(10) Pub. No.: US 2015/0039382 A1
(43) Pub. Date: Feb. 5, 2015

(54) METHOD AND SYSTEM FOR EXECUTING WORKFLOW

(71) Applicant: ELECTRONICS AND TELECOMMUNICATIONS RESEARCH INSTITUTE, Daejeon (KR)

(72) Inventor: Byoung Seob KIM, Daejeon (KR)

(73) Assignee: ELECTRONICS AND TELECOMMUNICATIONS RESEARCH INSTITUTE, Daejeon (KR)

(21) Appl. No.: 14/098,725

(22) Filed: Dec. 6, 2013

(30) Foreign Application Priority Data
Aug. 5, 2013 (KR) 10-2013-0092738

(51) Int. Cl. G06Q 10/06

(52) U.S. Cl. CPC G06Q 10/0633
USPC 705/7.27

(57) ABSTRACT

A cluster-based workflow system is provided which has the advantage of executing a workflow created by a non-IT researcher in a way that is suitable for computing resources in a cluster environment. The user can quickly analyze workflows using third-party applications, such as a large-scale bio data analysis workflow, a weather forecast data analysis workflow, or a customer relationship management (CRM) data analysis workflow, by using a large-scale computing cluster. In addition, third-party applications not optimized for a cluster environment can be automatically distributed and executed in parallel by preliminary analysis so that they run properly in the cluster environment.

### CROSS-REFERENCE TO RELATED APPLICATION

This application claims priority to and the benefit of Korean Patent Application No. 10-2013-0092738 filed in the Korean Intellectual Property Office on Aug. 5, 2013, the entire contents of which are incorporated herein by reference.

### BACKGROUND OF THE INVENTION

(a) Field of the Invention

The present invention relates to a method and system for executing a workflow on a cluster.

(b) Description of the Related Art

Nowadays, as the scale of analysis of IT data, such as web logs, web click data, or social network service (SNS) data, and scientific data, such as weather data or bio data, has increased and the analysis technology has advanced, there is a demand for a technique for fast analysis and processing of large volumes of data.

In response to this demand, enormous storage space has been secured in a general computer environment, and the data analysis environment has made the transition to a high-performance computer cluster environment where a variety of computing resources can be used. The high-performance computer cluster environment may include a high-speed processor such as a general-purpose computing on graphics processing units (GPGPU) or a many integrated core architecture (MIC architecture).

Initially, various third-party applications were sequentially integrated into a pipeline, and then data was analyzed. This method using a pipeline can be developed using a batch script.

After that, a workflow management system (WMS) emerged in order to enhance the scalability of batch scripts, make the maintenance of the batch scripts easy, and provide convenience. Scientists and service providers have become able to analyze data by organizing workflows (pipelines) easily and in various ways with the use of WMS.

The WMS has recently evolved into a grid-based workflow management system where a number of services are assembled together in a grid environment to define a pipeline and execute a pipeline. Users have become able to link a wide range of services together through the use of a grid-based workflow management system and analyze data using more resources. The grid-based workflow management system is designed so that data and execution flows are defined for services executed in other systems.

With the recent increase in the scale of data, the amount of data to be processed is growing larger and data processing increasingly requires a large amount of calculation resources, resulting in enormous amounts of data being transported over a network. For this reason, there is an increasing demand for analysis of data within a cluster.

However, the conventional WMS only provides a method of defining and executing a workflow suitable for linking services together outside a cluster system, but does not provide any method of defining and executing a workflow using several applications within a cluster system. In addition, the conventional WMS has limitations in its method of analyzing data in a distributed and parallel fashion. That is, users are supposed to determine the degree of parallelization of an application, even if the application supports the definition of distributed and parallel execution, thus making it difficult for a non-IT researcher to execute a workflow in a way suitable for computing resources in a cluster environment.

### SUMMARY OF THE INVENTION

The present invention has been made in an effort to provide a cluster-based workflow system having the advantage of executing a workflow created by a non-IT researcher in a way that is suitable for computing resources in a cluster environment.

An exemplary embodiment of the present invention provides a method for executing a workflow using the resources of a cluster. The workflow execution method includes: analyzing a workflow to create a test workflow and a test scenario from the workflow; executing the test workflow according to the test scenario; analyzing the execution log of the test workflow to extract optimal parallel execution information for the workflow; and executing the workflow in accordance with the optimal parallel execution information.

In the workflow execution method, the creating of a test workflow and a test scenario may include: parsing the workflow into a plurality of work items included in the workflow; determining whether the parsed work items can be executed in parallel; creating a test workflow for a work item that can be executed in parallel, depending on the determination result; and creating a test scenario based on the condition for parallel execution of the work item.

In the workflow execution method, the creating of a test workflow and a test scenario may include creating a test workflow for each of the plurality of work items.

In the workflow execution method, the condition for parallel execution may refer to the number of processes or threads that can be simultaneously executed on the resources of a cluster, and the creating of a test scenario may include creating a plurality of test scenarios each having a different number of processes or threads.

In the workflow execution method, the test scenario may comply with an XML format.

In the workflow execution method, the executing of the workflow may include: converting the workflow into a job format for a job and resource management system (JRMS) by using the optimal parallel execution information; and executing the converted workflow by using the JRMS.

Another exemplary embodiment of the present invention provides a system for executing a workflow using the resources of a cluster. The workflow execution system may include: a workflow analyzer that analyzes a workflow to create a test workflow and a test scenario from the workflow, and analyzes the execution log of the test workflow executed according to the test scenario to extract optimal parallel execution information for the workflow; and a workflow executer that executes the workflow in accordance with the optimal parallel execution information.

In the workflow execution system, the workflow analyzer may parse the workflow into a plurality of work items included in the workflow, determine whether the parsed work items can be executed in parallel, and create a test workflow for a work item that can be executed in parallel.

In the workflow execution system, the workflow analyzer may create a test scenario based on the condition for parallel execution of the work item.

In the workflow execution system, the workflow analyzer may create a test workflow for any work item that can be executed in parallel, among the plurality of work items.

In the workflow execution system, the condition for parallel execution may refer to the number of processes or threads that can be simultaneously executed on the resources of a cluster, and the workflow analyzer may create a plurality of test scenarios each having a different number of processes or threads.

In the workflow execution system, the test scenario may comply with an XML format.

In the workflow execution system, the workflow executer may convert the workflow into a job format for a job and resource management system (JRMS) by using the optimal parallel execution information, and execute the converted workflow by using the JRMS.

### BRIEF DESCRIPTION OF THE DRAWINGS

FIG. 1 is a view showing a cluster-based workflow management system according to an exemplary embodiment of the present invention.

FIG. 2 is a conceptual view of a graphical user interface-based workflow according to an exemplary embodiment of the present invention.

FIG. 3A to FIG. 3C are conceptual views showing workflow modeling according to the exemplary embodiment of the present invention.

FIG. 4 is a block diagram showing a cluster-based workflow system according to the exemplary embodiment of the present invention.

FIG. 5 is a flowchart showing the operation of a workflow analyzer of the cluster-based workflow system according to the exemplary embodiment of the present invention.

FIG. 6 is a flowchart showing the operation of a workflow executer of the cluster-based workflow system according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements. The terms such as “-unit”, “-er/-or”, “-module”, and “-block” stated in the specification may signify a unit to process at least one function or operation, and may be embodied by hardware, software, or a combination of hardware and software.

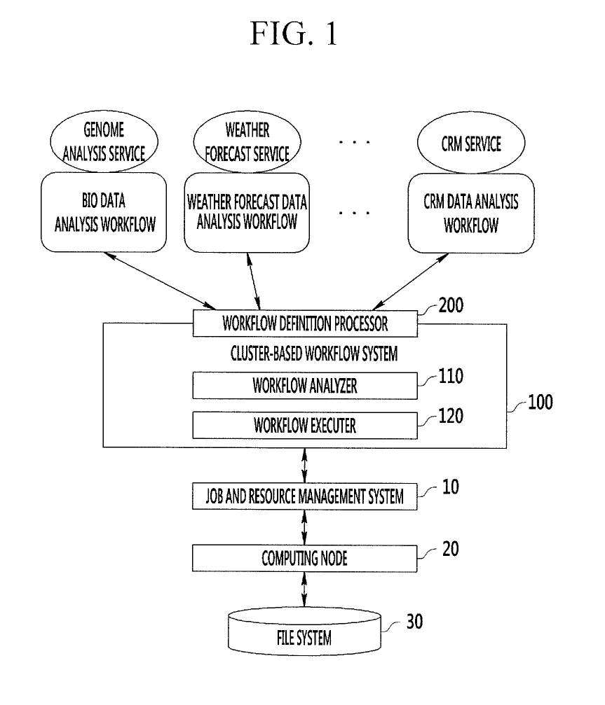

FIG. 1 is a view showing a cluster-based workflow management system according to an exemplary embodiment of the present invention.

Referring to FIG. 1, the workflow management system according to the exemplary embodiment of the present invention includes a cluster-based workflow system 100, a job and resource management system (JRMS) 10, a computing node 20, and a file system 30.

The cluster-based workflow system 100 includes a workflow definition processor 200, a workflow analyzer 110, and a workflow executer 120.

The workflow definition processor defines a workflow structure for analyzing data by integrating data and a third-party application program, and workflow execution information can be set up to execute a workflow defined by the workflow definition processor.

Examples of the workflow execution information may include the location of an input data file and parallel execution information.

A cluster-based workflow model according to the exemplary embodiment of the present invention provides both a workflow definition model and a workflow execution configuration model.

To execute a workflow, the workflow definition model can define the specification of each work item (or task) and the specification of input/output data of the work item. In addition, the workflow definition model can define the specification and procedure of workflow execution, including a workflow structure for displaying a link relationship between each work item.

The workflow execution configuration model is a model which, based on a defined workflow, sets up execution information, such as the location of input data and parallel execution information, which may be changed each time a workflow runs.

The workflow analyzer extracts optimal parallel execution information for parallel execution by creating a scenario and pre-analyzing a workflow. That is, if a user has a plan to run a particular workflow multiple times, the particular workflow can be analyzed through the workflow analyzer. The workflow analyzer analyzes a workflow, extracts optimal parallel execution information, and then stores the extracted optimal parallel execution information in metadata. Using the optimal parallel execution information provided by the workflow analyzer, the workflow executer converts the workflow into a job set for the JRMS so that the user workflow can be executed optimally in parallel. In addition, the workflow is processed by requesting the JRMS to process the converted job set.

The JRMS is a system which is used to efficiently execute a number of jobs by utilizing resources in a large-scale computing cluster environment. The JRMS can submit multiple jobs to a cluster and execute the jobs by using the resources of the cluster. A cluster-based workflow system according to an exemplary embodiment of the present invention can add a simple remote communication method, such as a socket or SSH (secure shell), as well as the JRMS. In this case, a conversion module of the workflow executer can be expanded. A cluster-based workflow system linked to the JRMS will be described below.

In addition, the cluster-based workflow system according to the exemplary embodiment of the present invention can use a cluster file system (cluster FS) or a global file system (global FS) as a file system. A cluster-based workflow system using a global file system will be described below.

Referring to FIG. 1, the user defines a user workflow by a workflow definition processor, and passes the user workflow which is to be repeatedly executed to the workflow analyzer. Then, the workflow analyzer extracts optimal parallel execution information for the user workflow. The optimal parallel execution information can be used when the workflow executer executes the user workflow.

The workflow analyzer analyzes the user workflow and then passes the optimal parallel execution information to the workflow executer, and the workflow executer executes the workflow by using the resources of the computing node and the file system. In this case, the workflow executer may use the resources of the computing node by using the JRMS.

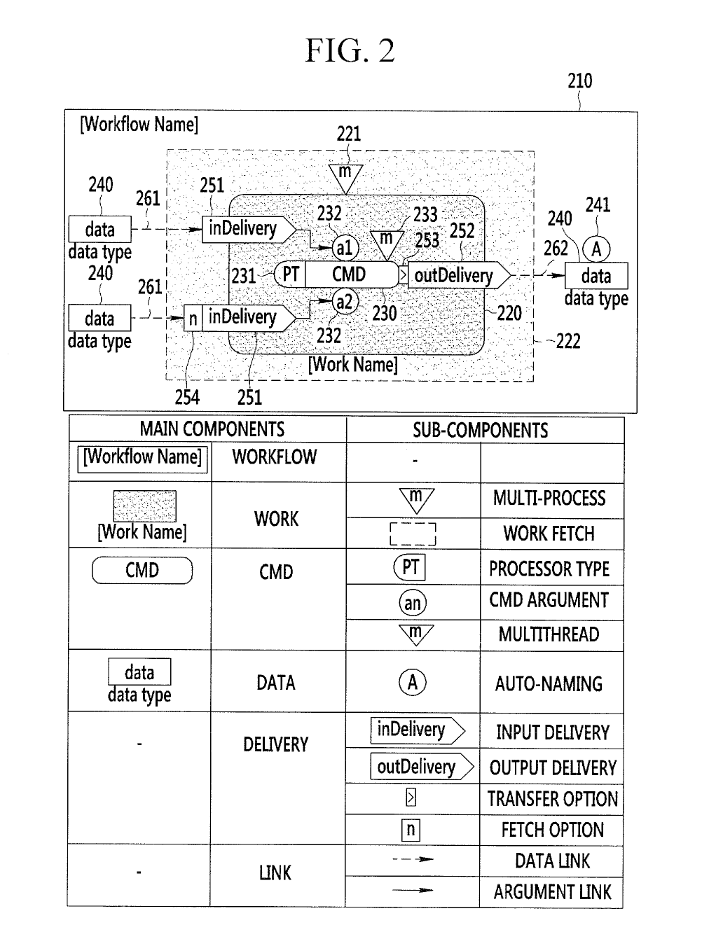

FIG. 2 is a conceptual view of a graphical user interface (GUI) based workflow according to an exemplary embodiment of the present invention.

Referring to FIG. 2, a conceptual view of a GUI based workflow includes a workflow component 210, a work component 220, a command (CMD) component 230, a data component 240, a delivery component, and a link component. In an exemplary embodiment of the present invention, the workflow component 210, the work component 220, the CMD component 230, the data component 240, the delivery component, and the link component are referred to as main components.

The workflow component 210 indicates the entire extent of a workflow, and may indicate the name of the workflow on the left upper corner of the graphical symbol. A single workflow may include a plurality of work items, and the work items are linked to each other by the data component 240.

The work component 220 indicates the extent of work included in the workflow, and may additionally include a plurality of CMDs. The name may be indicated at the bottom of the graphical symbol.

The work component 220 may include a multi-process component 221 and a work fetch component 222 as sub-components.

The multi-process component 221 indicates whether work items can be simultaneously performed or not. This can be indicated at the top of the work component 220. Each work item can be processed by fetching input data. In this case, the work fetch component 222 indicates the conceptual scope of data to be fetched. That is, the components included in the area indicated as the work fetch component 222 process the same fetched data. The number of input data items to be fetched by a single fetch operation can be indicated at a fetch option component 254.

The CMD component 230 indicates a third-party application. The representative name of a command may be indicated at the center of the graphical symbol.

The CMD component 230 includes a processor type component 231, CMD argument components 232, and a multithread component 233 as sub-components.

The processor type component 231 indicates the type of processor on which a command is used. A command used only on a CPU is indicated by “C” in the middle, a command used on both a CPU and a GPGPU is indicated by “G” in the middle, and a command used on both a CPU and a MIC is indicated by “M” in the middle. A command used on both a GPGPU and a MIC is indicated by “GM” in the middle.

The CMD argument components 232 indicate the arguments required for a CMD. The CMD argument components 232 may be indicated at the top and bottom of the CMD component 230, and the names a1 and a2 of the arguments may be indicated in the middle of the CMD argument components 232. To indicate arguments required to be in order, the arguments may be indicated from the top left to right of the CMD component or from bottom left to right of the CMD component 230.

The multithread component 233 indicates whether the command supports multithreading or not. If the command supports multithreading, the multithread component 233 is indicated at the top of the CMD component 230.

The data component 240 indicates data used to input and output work items. The data name may be indicated in the middle of the data component 240, and the data type may be indicated at the bottom of the data component 240. Table 1 shows data that can be indicated by the data type.

TABLE 1

| Supported data type | Description |
|---|---|
| string | 1 string |
| string List | string list |
| FilePath | 1 file path |
| FilePath List | file path list |

The data component 240 may include an auto-naming component 241 as a sub-component. If the workflow component includes two or more work items, the auto-naming component 241 is indicated at the top of the data component 240. If the user has not set up the name of an output file of the previous work item by themselves, the auto-naming component 241 may be indicated when the system automatically sets up a temporary file and delivers it to the next work item.

The delivery component indicates the destination of input data or output data. The delivery component includes an input delivery component 251, an output delivery component 252, a transfer option component 253, and a fetch option component 254 as sub-components.

The input delivery component 251 delivers data input as work to the CMD argument component 232, and the name of the work may be indicated in the middle of this component 232. A single input delivery component 251 may be mapped to a plurality of CMD argument components 232.

The output delivery component 252 may deliver the result of execution of a command in the CMD component 230 to an output data component, and the name of the command may be indicated in the middle of this component. A single output delivery component 252 may be mapped to the output data component or the CMD argument components of other commands.

The transfer option component 253 may indicate how the output delivery component 252 can deliver the result of the command. For instance, the transfer option component 253 is indicated as blank if the command does not require output description, is indicated as “|” when linking the command to the next command within a single work item, and is indicated as “>” when outputting the command as a file.

The fetch option component 254 may indicate the number of input data items to be fetched by a single fetch operation by the input delivery component 251. For example, “A” is indicated in the middle of the fetch option component 254 when fetching all data items by a single fetch operation, “1” is indicated when fetching one data item, and “2” is indicated when fetching two data items.

The link component may indicate a link between the data component and the delivery component or a link between the delivery component and the CMD argument components. The link component includes a data link component 261 and an argument link component 262 as sub-components.

The data link component 261 indicates a link between the data component 240 and the input delivery component 251 and a link between the output delivery component 252 and the data component 240.

The argument link component 262 indicates a link between the input delivery component 251 and the CMD argument component 232.

According to the exemplary embodiment of the present invention, the user may use the conceptual model of the cluster-based workflow as follows. First, the user sets the representative name of an application program, and sets up a string of commands to be actually executed. These are not indicated in the conceptual model.

Next, the user sets the type (CPU, GPGPU, MIC, etc.) of a processor that executes a command, and sets the types of input data and output data. The user links an input data component to the CMD argument components, links the result of command execution in the CMD component to the output data component, and sets the transfer option (“|”, “>”, etc.).

After that, the user sets the number (A, 1, 2, etc.) of data items to be processed each time a work item is executed, and also sets whether the command supports multithreading or not and whether work items can be multi-processed.

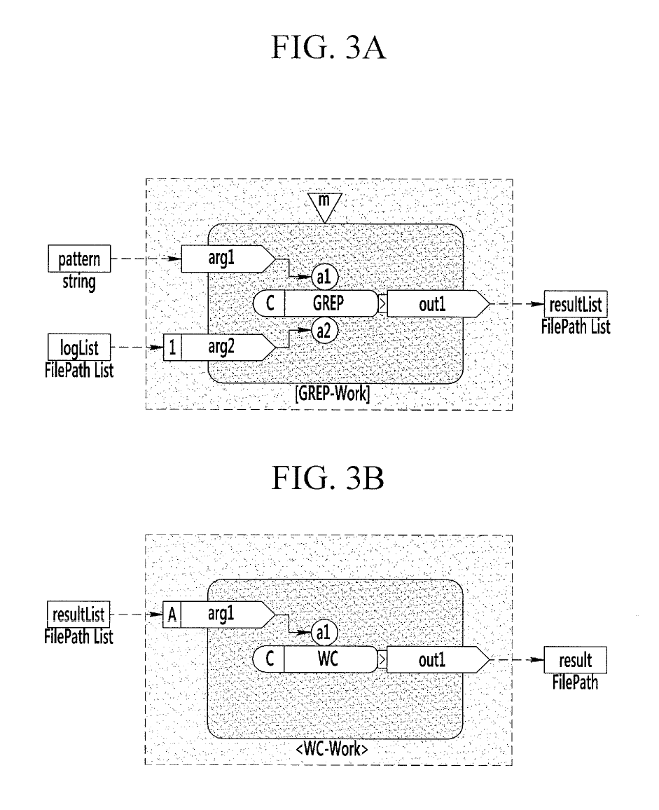

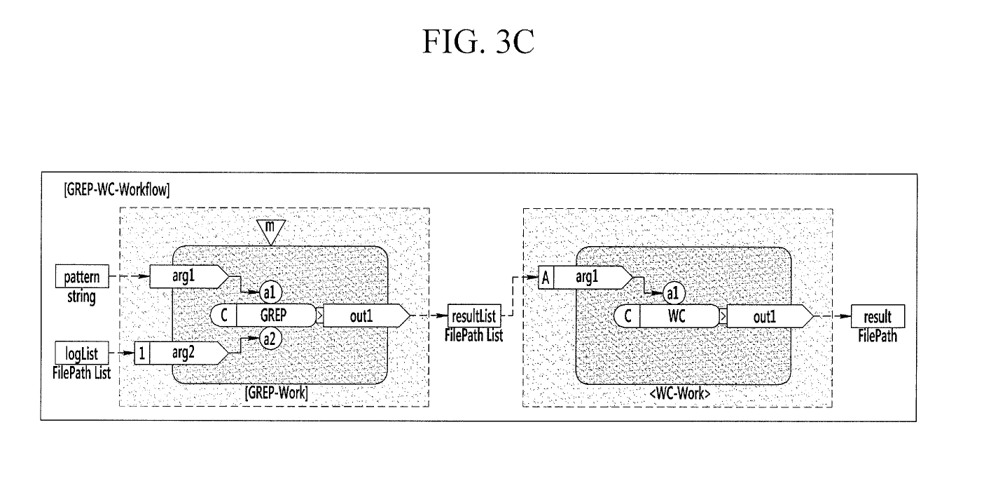

FIG. 3A to FIG. 3C are conceptual views showing workflow modeling according to the exemplary embodiment of the present invention.

Referring to FIG. 3A to FIG. 3C, the workflow modeling according to the exemplary embodiment of the present invention allows data to be processed using the “grep” command and “wc” command of Linux, and allows the following scenario to be executed.

### [Scenario]

“Analyze the web visit logs and count how many times ‘user 1’ has visited.”

A detailed scenario of data analysis on the scenario is as follows.

### [Detailed Scenarios]

1. Extract lines containing ‘user 1’ from each log file by using the grep command, and store the result as a file.

2. Count the number of lines contained in the stored file by using the wc command.

First, detailed scenario 1 is defined by using the grep command (FIG. 3A), detailed scenario 2 is defined by using the we command (FIG. 3B), and detailed scenario 1 and detailed scenario 2 are integrated to define a grep-wc workflow (FIG. 3C). FIG. 3A shows a conceptual work model for the grep command.

The grep command of Linux can be used as follows.
grep [OPTIONS] PATTERN [FILE . . . ]
   Also, GREP-work execution information stated in Table 2 is required in order to model a workflow using the grep command.

TABLE 2

| | |
|---|---|
| CMD Name | GREP |
| processor type | CPU |
| command | grep |
| isMultiThreading | false |
| arguments | a1: PATTERN |
| | a2: [FILE • • •] |

Then, input/output data information and optimal parallel execution information are required in order to execute the GREP-work conceptual model of FIG. 3A by using the information of Table 2. The optimal parallel execution information is a kind of execution information which is extracted by the workflow analyzer of the cluster-based workflow system. Once the workflow analyzer extracts optimal parallel execution information, the extracted optimal parallel execution information can be used when executing subsequent workflows. As such, there is no need to set up optimal parallel execution information as long as a workflow runs on the automatic setting.

Table 3 shows execution configuration information (input/output data information and optimal parallel execution information) for executing GREP-work.

TABLE 3

| Optimal- | | | | |
|---|---|---|---|---|
| parallel- | | | | |
| execution- | | | | |
| information [symbol] | Input data [symbol] | | Output data [symbol] | [symbol] |
| m = 5 [symbol] | pattern | logList | resultList | [symbol] |
| | user1 | location:/web/log | location:/result | |
| | | pathlist: | pathlist: | |
| | | 1. log | 1. out | |
| | | 2. log | 2. out | |
| | String | 3. log | 3. out | |
| | | 4. log | 4. out | |
| | | 5. log | 5. out | |
| | | <FilePath List> [symbol] | <FilePath List> | [symbol] |

FIG. 3B shows a conceptual work model for the wc command.

The wc command of Linux can be used as follows.
wc [OPTION] . . . [FILE] . . .

Also, WC-work execution information stated in Table 4 is required in order to model a workflow using the wc command.

TABLE 4

| | |
|---|---|
| CMD Name | WC |
| processor type | CPU |
| Command | wc |
| isMultiThreading | false |
| arguments | a1: [FILE] . . . |

Then, input/output data information is required in order to execute the WC-work conceptual model of FIG. 3B by using the information of Table 4. Table 5 shows execution configuration information (input/output data information) for executing WC-work.

TABLE 5

| Input data [symbol] | | Output data [symbol] | |
|---|---|---|---|
| resultList | | resultList | |
| location:/result | | location:/out | |
| pathlist: | | filename: | |
| 1. out | | visit_count.txt | |
| 2. out | | | |
| 3. out | | <FilePath List> | [symbol] |
| 4. out | | | |
| 5. out | | | |
| <FilePath List> | [symbol] | | |

Then, a GREP-WC-workflow shown in FIG. 3C can be defined by integrating the GREP-work of FIG. 3A and the WC-work of FIG. 3B.

Table 6 shows the specification of an extensible markup language (XML) schema as a modeling language for a cluster-based workflow system according to an exemplary embodiment of the present invention.

TABLE 6

<?xml version=“1.0” encoding=“UTF-8” ?>
<xsd:schema xmlns:xsd=“http://www.w3.org/2001/XMLSchema”
xmlns=“http://www.maha.org”
targetNamespace=“http://www.maha.org” elementFormDefault=
“qualified”>
<xsd:element name=“WorkFlow”>
<xsd:complexType>
<xsd:sequence>
<xsd:element name=“Work” maxOccurs=“unbounded”>
<xsd:complexType>
<xsd:sequence maxOccurs=“unbounded”>
<xsd:element name=“InputDelivery” maxOccurs=“unbounded”
minOccurs=“0”>
<xsd:complexType>
<xsd:sequence>
<xsd:element name=“InputDataLink”>
<xsd:complexType>
<xsd:attribute name=“inputDataName” type=“xsd:string” use=
“required”/>
</xsd:complexType>
</xsd:element>
<xsd:element name=“ArgumentLink” maxOccurs=“unbounded”
minOccurs=“0”>
<xsd:complexType>
<xsd:attribute name=“commandName” type=“xsd:string” use=
“required”/>
<xsd:attribute name=“argumentName” type=“xsd:string” use=
“required”/>
</xsd:complexType>
</xsd:element>
</xsd:sequence>
<xsd:attribute name=“name” type=“xsd:string” use=“required”/>
<xsd:attribute name=“fetchOption” type=“InputFetchType”/>
</xsd:complexType>
</xsd:element>
<xsd:element name=“CMD” maxOccurs=“unbounded”>
<xsd:complexType>
<xsd:sequence>
<xsd:element name=“Argument” minOccurs=“1” maxOccurs=
“unbounded”>
<xsd:complexType>
<xsd:attribute name=“name” type=“xsd:string” use=“required”/>
</xsd:complexType>
</xsd:element>
</xsd:sequence>
<xsd:attribute name=“name” type=“xsd:string” use=“required”/>
<xsd:attribute name=“processorType” type=“ProcessorType” use=
“required”/>
<xsd:attribute name=“command” type=“xsd:string” use=“required”/>
<xsd:attribute name=“isMultiThreading” type=“xsd:boolean” use=
“required”/>
<xsd:attribute name=“multiThreadOption” type=“xsd:string”/>
<xsd:attribute name=“help” type=“xsd:string”/>
</xsd:complexType>
</xsd:element>
<xsd:element name=“OutputDelivery” maxOccurs=“unbounded”>
<xsd:complexType>
<xsd:sequence>
<xsd:element name=“OutputDataLink” minOccurs=“0”>
<xsd:complexType>
<xsd:attribute name=“outputDataName” type=“xsd:string” use=
“required”/>
</xsd:complexType>
</xsd:element>
<xsd:element name=“ArgumentLink” maxOccurs=“unbounded”
minOccurs=“0”>
<xsd:complexType>
<xsd:attribute name=“commandName” type=“xsd:string” use=
“required”/>
<xsd:attribute name=“argumentName” type=“xsd:string” use=
“required”/>
</xsd:complexType>
</xsd:element>
</xsd:sequence>
<xsd:attribute name=“name” type=“xsd:string” use=“required”/>
<xsd:attribute name=“transferOption” use=“required” type=
“OutputTransferType”/>
</xsd:complexType>
</xsd:element>
</xsd:sequence>
<xsd:attribute name=“name” type=“xsd:string” use=“required”/>
<xsd:attribute name=“isMultiProcessing” type=“xsd:boolean” use=
“required”/>
</xsd:complexType>
</xsd:element>
<xsd:element name=“Data” maxOccurs=“unbounded”>
<xsd:complexType>
<xsd:attribute name=“name” type=“xsd:string” use=“required”/>
<xsd:attribute name=“type” use=“required”>
<xsd:simpleType>
<xsd:restriction base=“xsd:string”>
<xsd:enumeration value=“String”/>
<xsd:enumeration value=“StringList”/>
<xsd:enumeration value=“FilePath”/>
<xsd:enumeration value=“FilePathList”/>
</xsd:restriction>
</xsd:simpleType>
</xsd:attribute>
<xsd:attribute name=“isAutoNaming” type=“xsd:boolean” default=
“false”/>
</xsd:complexType>
</xsd:element>
</xsd:sequence>
<xsd:attribute name=“name” type=“xsd:string” use=“required”/>
</xsd:complexType>
</xsd:element>
<xsd:simpleType name=“all”>
<xsd:restriction base=“xsd:string”>
<xsd:enumeration value=“all”/>
</xsd:restriction>
</xsd:simpleType>
<xsd:simpleType name=“InputFetchType”>
<xsd:union memberTypes=“all xsd:nonNegativeInteger”/>
</xsd:simpleType>
<xsd:simpleType name=“ProcessorType”>
<xsd:restriction base=“xsd:string”>
<xsd:enumeration value=“CPU”/>
<xsd:enumeration value=“GPGPU”/>
<xsd:enumeration value=“MIC”/>
</xsd:restriction>
</xsd:simpleType>
<xsd:simpleType name=“OutputTransferType”>
<xsd:restriction base=“xsd:string”>
<xsd:enumeration value=“none”/>
<xsd:enumeration value=“|”/>
<xsd:enumeration value=“>”/>
</xsd:restriction>
</xsd:simpleType>
</xsd:schema>

In addition, Table 7 shows the specification of an XML schema for a workflow execution configuration model.

TABLE 7
<?xml version=“1.0” encoding=“UTF-8” ?>
<xsd:schema xmlns:xsd=“http://www.w3.org/2001/XMLSchema”
xmlns=“http://www.maha.org”
targetNamespace=“http://www.maha.org” elementFormDefault=
“qualified”>
<xsd:element name=“ExecutionData”>
<xsd:annotation>
<xsd:documentation>
A sample element
</xsd:documentation>
</xsd:annotation>
<xsd:complexType>
<xsd:sequence>
<xsd:element name=“MultipleConfig”>
<xsd:complexType>
<xsd:sequence>
<xsd:element name=“Work” minOccurs=“0” maxOccurs=“unbounded”>
<xsd:complexType>
<xsd:sequence>
<xsd:element name=“CMD” minOccurs=“0” maxOccurs=“unbounded”>
<xsd:complexType>
<xsd:attribute name=“name” type=“xsd:string” use=“required”/>
<xsd:attribute name=“multiThreadNumber” type=
“xsd:nonNegativeInteger”
use=“required”/>
</xsd:complexType>
</xsd:element>
</xsd:sequence>
<xsd:attribute name=“name” type=“xsd:string” use=“required”/>
<xsd:attribute name=“multiProcessNumber” type=
“xsd:nonNegativeInteger”
use=“required”/>
</xsd:complexType>
</xsd:element>
</xsd:sequence>
</xsd:complexType>
</xsd:element>
<xsd:element name=“DataSet”>
<xsd:complexType>
<xsd:sequence>
<xsd:element name=“Data” type=“DataType” maxOccurs=“unbounded”/>
</xsd:sequence>
</xsd:complexType>
</xsd:element>
</xsd:sequence>
</xsd:complexType>
</xsd:element>
<xsd:complexType name=“DataType”>
<xsd:choice>
<xsd:element name=“String” type=“xsd:string”/>
<xsd:element name=“StringList”>
<xsd:simpleType>
<xsd:list itemType=“xsd:string”/>
</xsd:simpleType>
</xsd:element>
<xsd:element name=“FilePath”>
<xsd:complexType>
<xsd:sequence>
<xsd:element name=“location” type=“xsd:string”/>
<xsd:element name=“FileName” type=“xsd:string”/>
</xsd:sequence>
</xsd:complexType>
</xsd:element>
<xsd:element name=“FilePathList”>
<xsd:complexType>
<xsd:sequence>
<xsd:element name=“location” type=“xsd:string”/>
<xsd:element name=“FileNameList”>
<xsd:simpleType>
<xsd:list itemType=“xsd:string”/>
</xsd:simpleType>
</xsd:element>
</xsd:sequence>
</xsd:complexType>
</xsd:element>
</xsd:choice>
<xsd:attribute name=“name” type=“xsd:string” use=“required”/>
</xsd:complexType>
</xsd:schema>

Table 8 shows the conceptual model (workflow definition) of FIG. 3C defined in an XML conforming to the XML schema specification.

TABLE 8

<?xml version=“1.0” encoding=“UTF-8” ?>
<WorkFlow name=“GREP-WC-Workflow”
xmlns:xsi=“http://www.w3.org/2001/XMLSchema-instance”
xsi:schemaLocation=“http://www.maha.org wTuner-Workflow-
Model.xsd”
xmlns=“http://www.maha.org”>
<!--+++++++++++++++++++++++++++++ Work1
+++++++++++++++++++++++++++++-->
<Work name=“GREP-Work” isMultiProcessing=“true”>
<InputDelivery name=“arg1”>
<InputDataLink inputDataName=“pattern”/>
<ArgumentLink commandName=“GREP” argumentName=“a1”/>
</InputDelivery>
<InputDelivery name=“arg2” fetchOption=“1”>
<InputDataLink inputDataName=“logList”/>
<ArgumentLink commandName=“GREP” argumentName=“a2”/>
</InputDelivery>
<CMD name=“GREP” processorType=“CPU” command=“grep”
isMultiThreading=“false”>
<Argument name=“a1”/>
<Argument name=“a2”/>
</CMD>
<OutputDelivery name=“out1” transferOption=“>“>
<OutputDataLink outputDataName=“resultList”/>
</OutputDelivery>
</Work>
<!--+++++++++++++++++++++++++++++ Work2
+++++++++++++++++++++++++++++-->
<Work name=“WC-Work” isMultiProcessing=“false”>
<InputDelivery name=“arg1” fetchOption=“all”>
<InputDataLink inputDataName=“resultList”/>
<ArgumentLink commandName=“WC” argumentName=“a1”/>
</InputDelivery>
<CMD name=“WC” processorType=“CPU” command=“wc -l”
isMultiThreading=“false”>
<Argument name=“a1”/>
</CMD>
<OutputDelivery name=“out1” transferOption=“>“>
<OutputDataLink outputDataName=“result”/>
</OutputDelivery>
</Work>
<!--+++++++++++++++++++++++++++++ Data Set
+++++++++++++++++++++++++++++-->
<!-- GREP-Work: input -->
<Data name=“pattern” type=“String”/>
<Data name=“logList” type=“FilePathList”/>
<!-- GREP-Work ==> WC-Work -->
<Data name=“resultList” type=“FilePathList”/>
<!-- WC-Work: output -->
<Data name=“result” type=“FilePathList”/>
</WorkFlow>

Table 9 shows a workflow execution configuration model of the conceptual model of FIG. 3C defined in an XML conforming to the XML schema specification.

TABLE 9
<?xml version=“1.0” encoding=“UTF-8” ?>
<ExecutionData xmlns:xsi=“http://www.w3.org/2001/XMLSchema-
instance”
xsi:schemaLocation=“http://www.maha.org

wTuner-ExecutionData-Model.xsd” xmlns=“http://www.maha.org”>

<MultipleConfig>
<Work name=“GREP-Work” multiProcessNumber=“5”/>
</MultipleConfig>
<DataSet>
<Data name=“pattern”>
<String>user1</String>
</Data>
<Data name=“logList”>
<FilePathList>
<location>/web/log</location>
<FileNameList>
1.log
2.log
3.log
4.log
5.log
</FileNameList>
</FilePathList>
</Data>
<Data name=“resultList”>
<FilePathList>
<location>/result</location>
<FileNameList>
1.out
2.out
3.out
4.out
5.out
</FileNameList>
</FilePathList>
</Data>
<Data name=“result”>
<FilePath>
<location>/out</location>
<FileName>visit_count.txt</FileName>
</FilePath>
</Data>
</DataSet>
</ExecutionData>

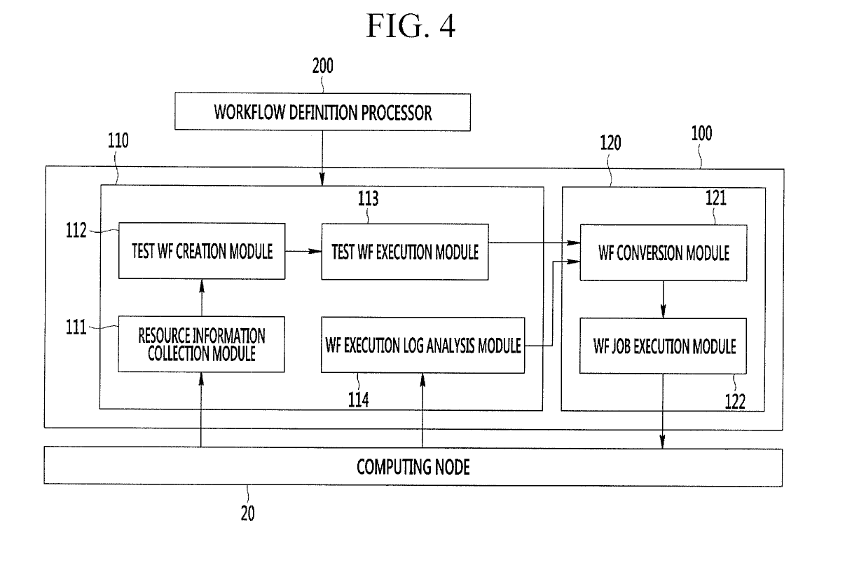

FIG. 4 is a block diagram showing a cluster-based workflow system according to the exemplary embodiment of the present invention.

Referring to FIG. 4, when a workflow defined by the workflow definition tool 200 is submitted, the cluster-based workflow system 100 according to the exemplary embodiment of the present invention analyzes the submitted workflow.

The workflow analyzer 110 includes a resource information collection module 111, a test workflow creation module 112, a test workflow execution module 113, and a workflow execution log analysis module 114.

The resource information collection module 111 collects resource information from the computing node 20 connected to the cluster-based workflow system 100.

The test workflow creation module 112 automatically creates a test workflow and a test scenario based on the resource information and a user workflow. The test scenario conforms to the format of execution configuration information.

The test workflow execution module 113 delivers the created test workflow and the created test scenario to a workflow executer 120.

The workflow execution log analysis module 114 analyzes log information on the test workflow executed according to the test scenario by the workflow executer 120 to extract optimal parallel execution information for optimally running an application.

The workflow executer 120 includes a workflow conversion module 121 and a workflow job execution module 122.

The workflow conversion module 121 converts the user workflow into a job format for the JRMS.

The workflow job execution module 122 executes the converted workflow according to the test scenario by using the JRMS.

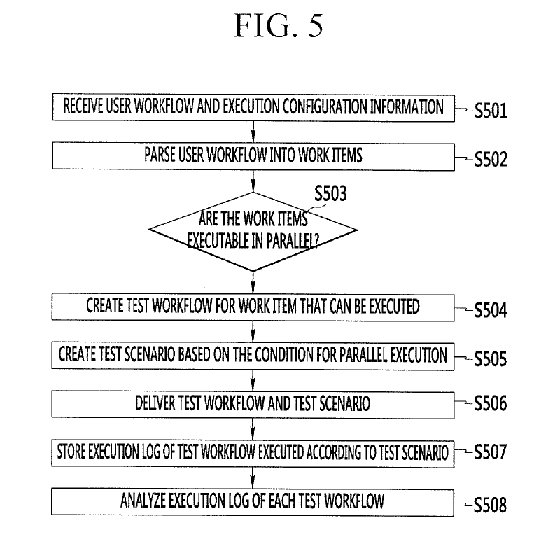

FIG. 5 is a flowchart showing the operation of a workflow analyzer of the cluster-based workflow system according to the exemplary embodiment of the present invention.

The workflow analyzer according to the exemplary embodiment of the present invention analyzes a user workflow to extract optimal parallel execution information. That is, when the user workflow is initially executed, optimal parallel execution information is extracted so that the extracted optimal parallel execution information is used for subsequent execution.

Referring to FIG. 5, when the user enters a user workflow and execution configuration information for execution of the user workflow (S501), the workflow analyzer parses the user workflow into a plurality of work items included in the user workflow by an XML parser (S502).

It is determined whether the parsed work items are executable in parallel (S503).

Then, a test workflow is created for any work item that can be executed in parallel, among the plurality of work items included in the user workflow (S504). On the other hand, no test workflow is created for any work item that cannot be executed in parallel, among the plurality of work items included in the user workflow. This is because, for a work item that cannot be executed in parallel, there is no need to create a test scenario for a coincidence test.

Subsequently, since the created test workflow is executable in parallel, the workflow analyzer creates a test scenario based on the condition for parallel execution of each work item (S505).

The condition for parallel execution of each work item refers to the number of processes or threads that can be simultaneously executed. The number of multi-processes or the number of multi-threads is associated with the number of cores present in the computer. Accordingly, the workflow analyzer can create a scenario while increasing the number of threads or the number of processes.

That is, the workflow executer executes a test workflow (for analysis) according to a variety of test scenarios created depending on the number of threads or processes, and the workflow analyzer analyzes the workflow execution logs of the workflow executer and extracts parallel execution information for a scenario in which the workflow is processed at the highest speed, that is, optimal parallel execution information.

A test scenario complies with an XML format. In addition, the workflow analyzer can additionally create a multi-threaded test scenario as long as the CMD in the work supports multithreading.

The test workflow execution module delivers a test workflow created by the test workflow creation module and a test scenario with the execution configuration information format to the workflow executer (S506). In this case, the workflow executer can store the execution log of the test workflow executed according to the test scenario as a file in the computing node or in a database management system (DBM) (S507).

The workflow execution log analysis module collects and analyzes test workflow execution logs stored by the workflow executer, and then extracts optimal parallel execution information and records the extracted optimal parallel execution information in metadata (S508). Afterwards, by combining the parallel execution information for the test workflows together, optimal parallel execution information for an initial user workflow can be recorded in metadata. The execution log of a test workflow can be analyzed based on the time consumed to execute the test workflow, the time consumed for each command, and so on.

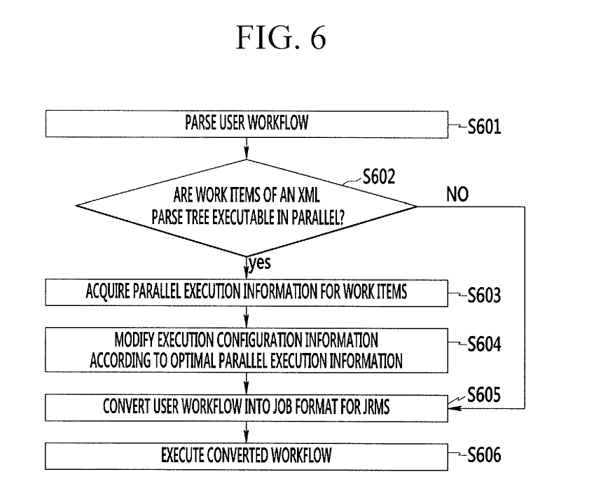

FIG. 6 is a flowchart showing the operation of a workflow executer of the cluster-based workflow system according to the exemplary embodiment of the present invention.

Referring to FIG. 6, the workflow conversion module of the workflow executer parses a user workflow entered by the user by using an XML parser (S601). The workflow conversion module then cycles through a list of work items of an XML parse tree and determines whether the work items can be executed in parallel (S602). If the work items can be executed in parallel, parallel execution information for the work items is acquired from optimal parallel execution information (S603), and execution configuration information entered by the user is modified according to optimal parallel execution information (S604).

Then, the workflow conversion module converts a user workflow into a job format for the JRMS (a job set for the JRMS) (S605).

The workflow execution module executes the converted workflow by using the JRMS (S606).

As seen above, with the use of a cluster-based workflow system according to an exemplary embodiment of the present invention, the user can quickly analyze workflows using third-party applications, such as a large-scale bio data analysis workflow, a weather forecast data analysis workflow, or a customer relationship management (CRM) data analysis workflow, by using a large-scale computing cluster. In addition, third-party applications not optimized for a cluster environment can be automatically executed in parallel by preliminary analysis so that they run properly on the cluster environment.

Moreover, the cluster-based workflow system according to the exemplary embodiment of the present invention allows the user to define a workflow as it is defined for a single node, by modeling the workflow after the same concept as an application program execution script (command) used in a single node. Additionally, it is possible to set whether work items are executable in parallel and whether application programs can be multithreaded. Furthermore, it is possible to set use of auxiliary processors such as GPGPU or to MIC and to allocate resources even in a cluster environment where a CPU and an auxiliary processor are used together.

Still further, the cluster-based workflow system can provide a method for delivering data between workflows in various ways such as a file, a memory, a socket, etc.). Particularly, if intermediate result data temporarily created for data delivery between work items is sent in a file, the cluster-based workflow system can allocate the intermediate result file within it, even if the user does not specify the file name, and deliver the intermediate result data to the next work item by using an intermediate medium (file, memory, etc.).

According to an embodiment of the present invention, the user can quickly analyze workflows using third-party applications, such as a large-scale bio data analysis workflow, a weather forecast data analysis workflow, or a customer relationship management (CRM) data analysis workflow, by using a large-scale computing cluster. In addition, third-party applications not optimized for a cluster environment can be automatically distributed and executed in parallel by preliminary analysis so that they run properly in the cluster environment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for executing a workflow using the resources of a cluster, the method comprising:
analyzing a workflow to create a test workflow and a test scenario from the workflow;
executing the test workflow according to the test scenario;
analyzing the execution log of the test workflow to extract optimal parallel execution information for the workflow; and
executing the workflow in accordance with the optimal parallel execution information.

2. The method of claim 1, wherein
the creating of a test workflow and a test scenario comprises:
parsing the workflow into a plurality of work items included in the workflow;
determining whether the parsed work items can be executed in parallel;
creating a test workflow for a work item that can be executed in parallel, depending on the determination result; and
creating a test scenario based on the condition for parallel execution of the work item.

3. The method of claim 2, wherein the creating of a test workflow and a test scenario comprises creating a test workflow for each of the plurality of work items.

4. The method of claim 2, wherein
the condition for parallel execution refers to the number of processes or threads that can be simultaneously executed on the resources of a cluster, and
the creating of a test scenario comprises creating a plurality of test scenarios each having a different number of processes or threads.

5. The method of claim 1, wherein the test scenario complies with an extensible markup language (XML) format.

6. The method of claim 1, wherein
the executing of the workflow comprises:
converting the workflow into a job format for a job and resource management system (JRMS) by using the optimal parallel execution information; and
executing the converted workflow by using the JRMS.

7. A system for executing a workflow using the resources of a cluster, the system comprising:
a workflow analyzer that analyzes a workflow to create a test workflow and a test scenario from the workflow, and analyzes the execution log of the test workflow executed according to the test scenario to extract optimal parallel execution information for the workflow; and
a workflow executer that executes the workflow in accordance with the optimal parallel execution information.

8. The system of claim 7, wherein the workflow analyzer parses the workflow into a plurality of work items included in the workflow, determines whether the parsed work items can be executed in parallel, and creates a test workflow for a work item that can be executed in parallel.

9. The system of claim 8, wherein the workflow analyzer creates a test scenario based on the condition for parallel execution of the work item.

10. The system of claim 9, wherein the workflow analyzer creates a test workflow for any work item that can be executed in parallel, among the plurality of work items.

11. The system of claim 9, wherein
the condition for parallel execution refers to the number of processes or threads that can be simultaneously executed on the resources of a cluster, and
the workflow analyzer creates a plurality of test scenarios each having a different number of processes or threads.

12. The system of claim 7, wherein the test scenario complies with an extensible markup language (XML) format.

13. The system of claim 7, wherein the workflow executer converts the workflow into a job format for a job and resource management system (JRMS) by using the optimal parallel execution information and executes the converted workflow by using the JRMS.
